(19) United States
(12) Patent Application Publication
(10) Pub. No.: US 2006/0177736 A1
(43) Pub. Date: Aug. 10, 2006

(54) Nickel-metal hydride storage battery and method of manufacturing the same

(76) Inventors: Tetsuyuki Murata, Kobe-shi (JP); Shigekazu Yasuoka, Kobe-shi (JP); Yoshifumi Magari, Kobe-shi (JP); Jun Ishida, Kobe-shi (JP)

Correspondence Address: KUBOVCIK & KUBOVCIK, SUITE 710, 900 17TH STREET NW, WASHINGTON, DC, 20006, US

(21) Appl. No.: 11/348,261

(22) Filed: Feb. 7, 2006

(30) Foreign Application Priority Data
Feb. 9, 2005 (JP) 2005-033456

(51) Int. Cl. H01M 4/58; H01M 4/62

(52) U.S. Cl. 429/218.2; 429/232

(57) ABSTRACT

A nickel-hydrogen storage battery provided with a positive electrode, an alkaline electrolyte solution, and a negative electrode containing a hydrogen-absorbing alloy represented by the general formula RE₁₋ₓMgₓNi_{y}Al_{z}Mₐ, where RE is at least one element selected from the group consisting of Zr, Hf, and a rare-earth element including Y; M is an element other than the group IA elements, the group VIIB elements, the group 0 elements, the RE, Mg, Ni, and Al; 0.10≦x≦0.30; 2.8≦y≦3.6; 0<z≦0.30; and 3.0≦y+z+a≦3.6, a zirconium compound being added to the negative electrode.

### BACKGROUND OF THE INVENTION

1. Field of the Invention

The present invention relates to a nickel-hydrogen storage battery provided with a positive electrode, a negative electrode employing a hydrogen-absorbing alloy, and an alkaline electrolyte solution, and to a method of manufacturing the nickel-hydrogen storage battery. More particularly, the invention relates to a nickel-hydrogen storage battery using, for its negative electrode so as to enhance the capacity of the nickel-hydrogen storage battery, a hydrogen-absorbing alloy represented by the general formula RE₁₋ₓMgₓNi_{y}Al_{z}Mₐ, wherein RE is at least one element selected from the group consisting of Zr, Hf, and a rare-earth element including Y; M is an element other than the group IA elements, the group VIIB elements, the group 0 elements, the just-noted RE, Mg, Ni, and Al; 0.10≦x≦0.30; 2.8≦y≦3.6; 0<z≦0.30; and 3.0≦y+z+a≦3.6. A feature of the invention is to prevent deterioration of the hydrogen-absorbing alloy due to oxidation of the hydrogen-absorbing alloy so as to improve the cycle life of the nickel-hydrogen storage battery.

2. Description of Related Art

Conventionally, nickel-cadmium storage batteries have been commonly used as alkaline storage batteries. In recent years, nickel-metal hydride storage batteries using a hydrogen-absorbing alloy as a material for their negative electrodes have drawn considerable attention in that they have higher capacity than nickel-cadmium storage batteries and that, being free of cadmium, they are more environmentally safe.

As the nickel-metal hydride storage batteries have been used in various portable devices, demands for further higher performance in the nickel-metal hydride storage batteries have been increasing.

In the nickel-metal hydride storage batteries, hydrogen-absorbing alloys such as a rare earth-nickel hydrogen-absorbing alloy having a CaCu₅ crystal structure as its main phase and a Laves phase hydrogen-absorbing alloy containing Ti, Zr, V and Ni have been generally used for their negative electrodes.

However, these hydrogen-absorbing alloys do not necessarily have sufficient hydrogen-absorbing capability, and it has been difficult to increase the capacity of the nickel-metal hydride storage batteries further.

In recent years, it has been proposed to increase the capacity of nickel-hydrogen storage batteries by using, for the negative electrode, a rare earth-Mg-nickel hydrogen-absorbing alloy in which Mg or the like is added to the rare earth-nickel hydrogen-absorbing alloy to improve the hydrogen-absorbing capability. (See, for example, Japanese Published Unexamined Patent Application No. 2001-316744.)

Nevertheless, the rare earth-Mg-nickel hydrogen-absorbing alloy as mentioned above tends to be oxidized more easily than the rare earth-nickel hydrogen-absorbing alloy having a CaCu₅ type crystal as its main phase. As a nickel-hydrogen storage battery using the hydrogen-absorbing alloy undergoes charge-discharge cycles, the hydrogen-absorbing alloy is oxidized and deteriorated, leading to the problem of poor cycle life of the nickel-hydrogen storage battery.

### BRIEF SUMMARY OF THE INVENTION

Accordingly, an object of the present invention is, with a nickel-hydrogen storage battery adopting a rare earth-Mg-nickel hydrogen-absorbing alloy for its negative electrode, to increase the capacity, to prevent the rare earth-Mg-nickel hydrogen-absorbing alloy used for the negative electrode from being oxidized and deteriorated and to thereby improve the cycle life of the nickel-hydrogen storage battery.

In order to accomplish the foregoing and other objects, the present invention provides a nickel-hydrogen storage battery comprising: a positive electrode; an alkaline electrolyte solution; and a negative electrode containing a hydrogen-absorbing alloy represented by the general formula RE₁₋ₓMgₓNi_{y}Al_{z}Mₐ, where RE is at least one element selected from the group consisting of Zr, Hf, and a rare-earth element including Y; M is an element other than the group IA elements, the group VIIB elements, the group 0 elements, the just-noted RE, Mg, Ni, and Al; 0.10≦x≦0.30; 2.8≦y≦3.6; 0<z≦0.30; and 3.0≦y+z+a≦3.6, the negative electrode having a zirconium compound added thereto.

### BRIEF DESCRIPTION OF THE DRAWING

FIG. 1 is a schematic cross-sectional view of a nickel-hydrogen storage battery fabricated in Examples 1 to 4 of the invention and Comparative Examples 1 to 3.

### DETAILED DESCRIPTION OF THE INVENTION

The nickel-hydrogen storage battery according to the present invention comprises: a positive electrode; an alkaline electrolyte solution; and a negative electrode containing a hydrogen-absorbing alloy represented by the general formula RE₁₋ₓMgₓNi_{y}Al_{z}Mₐ, where RE is at least one element selected from the group consisting of Zr, Hf, and a rare-earth element including Y; M is an element other than the group IA elements, the group VIIB elements, the group 0 elements, the just-noted RE, Mg, Ni, and Al; 0.10≦x≦0.30; 2.8≦y≦3.6; 0<z≦0.30; and 3.0≦y+z+a≦3.6. The negative electrode has a zirconium compound added thereto.

In the nickel-hydrogen storage battery of the invention, the zirconium compound may be, for example, zirconium oxide. It is preferable that, when adding zirconium oxide to the negative electrode, the zirconium oxide is added to the hydrogen-absorbing alloy in an amount of from 0.25 weight % to 0.35 weight % with respect to the hydrogen-absorbing alloy.

It is preferable that the nickel-hydrogen storage battery be aged, i.e., set aside or left to stand, until voltage is stabilized before being initially charged. In addition, it is preferable that the nickel-hydrogen storage battery be aged at a temperature within the range of from 45° C. to 80° C.

In the nickel-hydrogen storage battery of the invention, when a zirconium compound is added to the negative electrode containing the hydrogen-absorbing alloy represented by the general formula RE₁₋ₓMgₓNi_{y}Al_{z}Mₐ, where: RE is at least one element selected from the group consisting of Zr, Hf, and a rare-earth element including Y; M is an element other than the group IA elements, the group VIIB elements, the group 0 elements, the just-noted RE, Mg, Ni, and Al; 0.10≦x≦0.30; 2.8≦y≦3.6; 0<z≦0.30; and 3.0≦y+z+a≦3.6, zirconium in the zirconium compound acts on the magnesium in the hydrogen-absorbing alloy, serving to improve the conductive network in the negative electrode.

As a result, in the nickel-hydrogen storage battery of the invention, the charge-discharge performance improves, enhancing the charge-discharge cycle performance, and at the same time, the low temperature discharge capability and the high rate discharge capability also improve.

Here, if the amount of the zirconium compound added to the negative electrode is too small, the above-described advantageous effects cannot be attained sufficiently. On the other hand, if the amount of the zirconium compound is too large, conductivity in the negative electrode is reduced. For this reason, it is preferable that, when adding zirconium oxide as the zirconium compound, the amount of zirconium oxide added be controlled within the range of from 0.25 weight % to 0.35 weight % with respect to the weight of the hydrogen-absorbing alloy.

In the case that a nickel-hydrogen storage battery is fabricated with adding a zirconium compound to the negative electrode as described above, the open circuit voltage before the nickel-hydrogen storage battery is initially charged becomes lower than that in the case that the zirconium compound is not added. Consequently, the rate of increase in the open circuit voltage is slow, and the initial charge process is carried out with the open circuit voltage that stays low. If the initial charging is started in this way with the open circuit voltage remaining low, the hydrogen overvoltage is raised and hydrogen gas is produced. Thereby, the battery internal pressure increases, causing the alkaline electrolyte solution to be released to the outside. As a result, the internal resistance of the nickel-hydrogen storage battery increases, lowering the charge-discharge cycle performance, and the above-described advantageous effects originating from the addition of a zirconium compound to the negative electrode is lessened.

In this invention, when the nickel-hydrogen storage battery is aged before it is initially charged, the open circuit voltage before initially charging the nickel-hydrogen storage battery increases, making it possible to prevent the rise of the battery internal pressure associated with the rise of the hydrogen overvoltage at the time of initial charging. Thus, the above-described advantageous effects originating from the addition of the zirconium compound to the negative electrode will be sufficiently attained.

When aging the nickel-hydrogen storage battery before initially charging the battery, the aging may take a long time if the battery is aged at too low a temperature. On the other hand, if the battery is aged at too high a temperature, the hydrogen-absorbing alloy may be oxidized and deteriorated. Therefore, it is preferable that the battery be aged at a temperature within the range of from 45° C. to 80° C. In the case that the battery is aged at 45° C., for example, it is preferable that the battery be aged for 12 hours or longer.

Hereinbelow, examples of the nickel-metal hydride storage battery according to the invention are specifically described along with comparative examples, and it will be demonstrated that the examples of the nickel-metal hydride storage battery according to the invention exhibit improved cycle life as well as improved low temperature discharge capability and enhanced high rate discharge capability. It should be construed, however, that the nickel-metal hydride storage battery according to the invention is not limited to the examples illustrated in the following, and various changes and modifications may be made without departing from the scope of the invention.

### EXAMPLE 1

In Example 1, the hydrogen-absorbing alloy used for the negative electrode was prepared as follows. Rare-earth elements La, Pr, and Nd as well as Zr, Mg, Ni, Al, and Co were mixed together so that the alloy composition became La_{0.17}Pr_{0.41}Nd_{0.24}Zr_{0.01}Mg_{0.17}Ni_{3.03}Al_{0.17}Co_{0.10}. Thereafter the mixture was melted by high frequency induction melting and cooled, whereby an ingot of hydrogen-absorbing alloy having the just-noted composition was prepared.

The resultant ingot of hydrogen-absorbing alloy was annealed in an argon atmosphere at a temperature of 950° C., and the resultant was pulverized with the use of a mortar in an air atmosphere and classified using a sieve. Thus, hydrogen-absorbing alloy powder with the above-noted composition and an average grain size of 65 μm was prepared.

The negative electrode was prepared as follows. 0.25 parts by weight (0.25 weight %) of zirconium oxide was added to 100 parts by weight of the just-described hydrogen-absorbing alloy powder, and further, 0.5 parts by weight of polyethylene oxide and 0.6 parts by weight of polyvinyl pyrrolidone, serving as binder agents, were added thereto. The mixture was kneaded to prepare a slurry. Then, the slurry was uniformly applied onto both sides of a nickel-plated punched metal. The resultant material was dried and thereafter cut into predetermined dimensions, to thus prepare a negative electrode.

The positive electrode was prepared as follows. 0.1 parts by weight of hydroxypropylcellulose serving as a binder agent was added to 100 parts by weight of nickel hydroxide powder, and these were kneaded to prepare a slurry. Then, the slurry was filled into a foamed metal. The resultant material was dried and pressed, and thereafter cut into predetermined dimensions, to thus prepare a positive electrode.

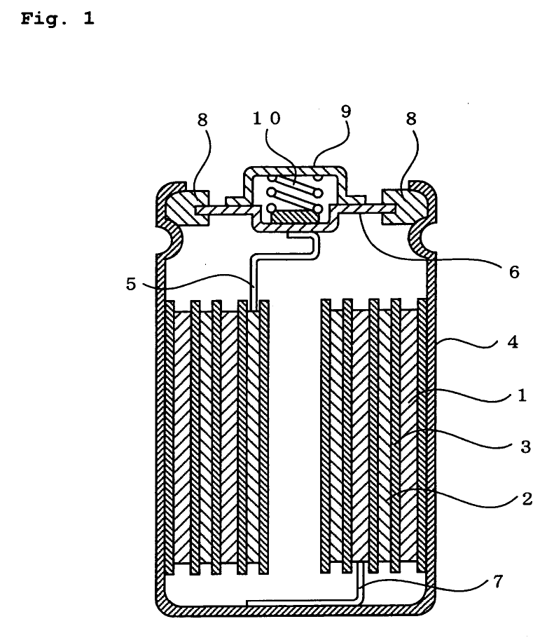

Then, a cylindrical nickel-hydrogen storage battery having a design capacity of 1500 mAh, as illustrated in FIG. 1, was fabricated using polypropylene nonwoven fabric as the separator and using 30 weight % alkaline electrolyte solution containing KOH, NaOH, and LiOH at a weight ratio of 10:1:2 as the alkaline electrolyte solution. The battery was then set aside at room temperature.

The just-described nickel-metal hydride storage battery was fabricated according to the following manner. A positive electrode 1 and a negative electrode 2 were spirally coiled with a separator 3 interposed therebetween, as illustrated in FIG. 1, and these were accommodated in a battery can 4. Then, 2.3 g of the alkaline electrolyte solution was poured into the battery can 4. Thereafter, an insulative packing 8 was placed between the battery can 4 and a positive electrode cap 6, and the battery can 4 was sealed. The positive electrode 1 was connected to the positive electrode cap 6 by a positive electrode lead 5, and the negative electrode 2 was connected to the battery can 4 via a negative electrode lead 7. The battery can 4 and the positive electrode cap 6 were electrically insulated by the insulative packing 8. A coil spring 10 was placed between the positive electrode cap 6 and a positive electrode external terminal 9. The coil spring 10 can be compressed to release gas from the interior of the battery to the atmosphere when the internal pressure of the battery unusually increases.

### COMPARATIVE EXAMPLE 1

In Comparative Example 1, a nickel-hydrogen storage battery was fabricated in the same manner as in Example 1 above, except that zirconium oxide was not added to the hydrogen-absorbing alloy in preparing the hydrogen-absorbing alloy. The nickel-hydrogen storage battery thus fabricated was set aside at room temperature, as in the case of Example 1 above.

### EXAMPLE 2

As the nickel-hydrogen storage battery of Example 2, a nickel-hydrogen storage battery fabricated in accordance with the foregoing Example 1 was aged at 45° C. for 12 hours.

### COMPARATIVE EXAMPLE 2

In Comparative Example 2, a nickel-hydrogen storage battery was fabricated without adding zirconium oxide to the hydrogen-absorbing alloy, in the same manner as in Comparative Example 1 above, and the nickel-hydrogen storage battery was aged at 45° C. for 12 hours, as in the case of Example 2 above.

### EXAMPLE 3

As the nickel-hydrogen storage battery of Example 3, a nickel-hydrogen storage battery fabricated in accordance with the foregoing Example 1 was aged at 80° C. for 12 hours.

### COMPARATIVE EXAMPLE 3

In Comparative Example 3, a nickel-hydrogen storage battery was fabricated without adding zirconium oxide to the hydrogen-absorbing alloy, in the same manner as in Comparative Example 1 above, and the nickel-hydrogen storage battery was aged at 80° C. for 12 hours, as in the case of Example 3 above.

### EXAMPLE 4

In Example 4, a nickel-hydrogen storage battery was fabricated in the same manner as in Example 1 above, except that 0.35 parts by weight (0.35 weight %) of zirconium oxide was added to 100 parts by weight of the above-described hydrogen-absorbing alloy in preparing the hydrogen-absorbing alloy. The nickel-hydrogen storage battery thus fabricated was aged at 45° C. for 12 hours, as in the case of Example 2 above.

Next, the open circuit voltages of the thus-prepared nickel-hydrogen storage batteries of Examples 1 to 3 and Comparative Examples 1 to 3 were measured at the stage before the batteries were activated. Table 1 below shows the difference in open circuit voltages between the nickel-hydrogen storage battery of Comparative Example 1 and the nickel-hydrogen storage battery of Example 1, the difference in open circuit voltages between the nickel-hydrogen storage battery of Comparative Example 2 and the nickel-hydrogen storage battery of Example 2, and the difference in open circuit voltages between the nickel-hydrogen storage battery of Comparative Example 3 and the nickel-hydrogen storage battery of Example 3, taking the open circuit voltages of the nickel-hydrogen storage batteries of Comparative Examples 1 to 3 as the references.

Then, each of the nickel-hydrogen storage batteries of Examples 1 to 4 and Comparative Examples 1 to 3 was charged with a current of 150 mA at a temperature of 25° C. for 16 hours, and thereafter discharged at a current of 300 mA until the battery voltage reached 1.0 V, to thereby activate the nickel-hydrogen storage batteries.

Then, the thus-activated nickel-hydrogen storage batteries of Examples 1 to 3 and Comparative Examples 1 to 3 were charged with a current of 1500 mA at a temperature of 25° C. After the battery voltage reached the maximum value, the batteries were further charged until the voltage lowered by 10 mV, and set aside for 1 hour. Thereafter, the batteries were discharged at a current of 1500 mA until the battery voltage reached 1.0 V. This charge-discharge cycle was repeated to obtain the cycle life of each of the batteries, at which the discharge capacity of each battery lowered to 60% of the discharge capacity at the first cycle. The cycle life of each of the nickel-hydrogen storage batteries was calculated taking the cycle life of the nickel-hydrogen storage battery of Comparative Example 1 as the reference value 100. The results are also shown in Table 1 below.

TABLE 1

| | Additive to hydrogen- | | | | |
|---|---|---|---|---|---|
| | absorbing alloy | | | Difference in | |
| | | Amount | Aging | open circuit | |
| | | added | temperature | voltage | Cycle |
| | Zr compound | (wt. %) | (° C.) | (V) | life |
| Ex. 1 | ZrO₂ | 0.25 | — | −0.017 | 102 |
| Comp. | — | — | — | — | 100 |
| Ex. 1 | | | | | |
| Ex. 2 | ZrO₂ | 0.25 | 45 | +0.004 | 114 |
| Comp. | — | — | 45 | — | 101 |
| Ex. 2 | | | | | |
| Ex. 3 | ZrO₂ | 0.25 | 80 | +0.005 | 105 |
| Comp. | — | — | 80 | — | 101 |
| Ex. 3 | | | | | |
| Ex. 4 | ZrO₂ | 0.35 | 45 | — | 119 |

Consequently, a comparison between the open circuit voltages demonstrates that the nickel-hydrogen storage battery of Example 1, which was set aside at room temperature, showed a lower open circuit voltage than that of the nickel-hydrogen storage battery of Comparative Example 1, while both the nickel-hydrogen storage batteries of Examples 2 and 3, which were aged for 12 hours at temperatures of 45° C. and 80° C., respectively, showed higher open circuit voltages than those of the respective nickel-hydrogen storage batteries of Comparative Examples 2 and 3, in which zirconium oxide was not added to the negative electrodes.

The nickel-hydrogen storage batteries of Examples 1 to 4, in each of which zirconium oxide was added to the negative electrode, exhibited improved cycle life over the nickel-hydrogen storage batteries of Comparative Examples 1 to 3, in each of which zirconium oxide was not added to the negative electrode.

Moreover, a comparison between the nickel-hydrogen storage batteries of Examples 1 to 4, in each of which zirconium oxide was added to the negative electrode, demonstrates that the nickel-hydrogen storage batteries of Examples 2 to 4, which were aged at a temperature of 45° C. or 80° C. for 12 hours, exhibited better cycle life than the nickel-hydrogen storage battery of Example 1, which was set aside at room temperature. In particular, the nickel-hydrogen storage batteries of Examples 2 and 4, which were aged at a temperature of 45° C. for 12 hours, showed greater improvements in cycle life.

Furthermore, a comparison between the nickel-hydrogen storage batteries of Examples 2 and 4, which were aged at a temperature of 45° C. for 12 hours, indicates that the nickel-hydrogen storage battery of Example 4, in which zirconium oxide was added to the hydrogen-absorbing alloy powder in an amount of 0.35 weight % with respect to the hydrogen-absorbing alloy powder, showed a further improved cycle life over the nickel-hydrogen storage battery of Example 2, in which zirconium oxide was added to the hydrogen-absorbing alloy powder in an amount of 0.25 weight % with respect to the hydrogen-absorbing alloy powder.

Next, low temperature discharge capabilities of the nickel-hydrogen storage batteries of Examples 2, 4 and Comparative Example 2 were found in the following manner. After the nickel-hydrogen storage batteries were activated in the manner described above, they were charged with a current of 1500 mA at a temperature of 25° C., as described above. After the battery voltage reached the maximum value, the batteries were further charged until the voltage lowered by 10 mV and were then set aside for 1 hour. Subsequently, they were discharged at a current of 1500 mA until the battery voltage reached 1.0 V, so that the charge-discharge process was performed for one cycle. Thereafter, the batteries were again charged with a current of 1500 mA at a temperature of 25° C. After the battery voltage reached the maximum value, the batteries were further charged until the voltage lowered by 10 mV and were then set aside for 3 hours at a low temperature of −10° C. Subsequently, the batteries were discharged at a current of 1500 mA under a low temperature of −10° C. until the battery voltage reached 1.0 V, to measure their discharge capacities under the low-temperature discharge. Then, the percentages of the discharge capacities under the low-temperature discharge with respect to the discharge capacities at the first cycle were obtained, and the obtained values were employed as the low temperature discharge capabilities. The low temperature discharge capability values are shown in Table 2 below.

In addition, high rate discharge capabilities of the nickel-hydrogen storage batteries of Examples 2, 4 and Comparative Example 2 were found in the following manner. After the nickel-hydrogen storage batteries were activated in the manner described above, they were charged and discharged for one cycle at a temperature of 25° C. in the manner described above. Thereafter, the batteries were charged with a current of 1500 mA at a temperature of 25° C., as described above. After the battery voltage reached the maximum value, the batteries were further charged until the voltage lowered by 10 mV and were then set aside for 1 hour. Thereafter, the batteries were discharged at a high current of 6000 mA until the battery voltage reached 1.0 V, to measure their discharge capacities under the high rate discharge. Then, the percentages of the discharge capacities under the high rate discharge with respect to the discharge capacities at the first cycle were obtained, and the obtained values were employed as the high rate discharge capabilities. The high rate discharge capability values are also shown in Table 2 below.

Moreover, mid point voltages and internal resistances of the nickel-hydrogen storage batteries of Examples 2, 4 and Comparative Example 2 were found in the following manner. After the nickel-hydrogen storage batteries were activated in the manner described above, they were charged with a current of 1500 mA at a temperature of 25° C., as described above. After the battery voltage reached the maximum value, the batteries were further charged until the voltage lowered by 10 mV and were then set aside for 1 hour. Thereafter, the batteries were discharged at a current of 1500 mA until the battery voltage reached 1.0 V, and were set aside for 1 hour. This charge-discharge process was repeated for 200 cycles, to measure the mid point voltages and internal resistances of the nickel-hydrogen storage batteries at the 200th cycle. The results are shown in Table 2 below.

TABLE 2

| | Low | | | |
|---|---|---|---|---|
| | temperature | High rate | | |
| | discharge | discharge | Midpoint | Internal |
| | capability | capability | voltage | resistance |
| | (%) | (%) | (V) | (mΩ) |
| Ex. 2 | 59.2 | 64.2 | 1.188 | 31.8 |
| Ex. 4 | 63.6 | 67.0 | 1.191 | 30.7 |
| Comp. | 59.1 | 62.5 | 1.185 | 34.5 |
| Ex. 2 | | | | |

The results demonstrate that the nickel-hydrogen storage batteries of Examples 2 and 4, which were aged for 12 hours at a temperature of 45° C. and in which zirconium oxide was added to the negative electrodes, exhibited better low temperature discharge capabilities and better high rate discharge capabilities, and at the same time higher midpoint voltages and lower internal resistances at the 200th cycle, than those of the nickel-hydrogen storage battery of Comparative Example 2, in which zirconium oxide was not added to the negative electrode and which was aged at a temperature of 45° C. for 12 hours. This is believed to be because, when zirconium oxide was added to the negative electrode, zirconium acted on the magnesium in the hydrogen-absorbing alloy, serving to improve the conductive network in the negative electrode. In particular, the nickel-hydrogen storage battery of Example 4, in which zirconium oxide was added to the hydrogen-absorbing alloy powder in an amount of 0.35 weight % with respect to the hydrogen-absorbing alloy powder, exhibited greater improvements in low temperature discharge capability and high rate discharge capability, as well as a higher midpoint voltage and a lower internal resistance at 200th cycle.

Although the foregoing examples used zirconium oxide as the zirconium compound added to the negative electrode, it is believed that the same advantageous effects will be obtained with other zirconium compounds than zirconium oxide such as, for example, zirconium hydride.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and not for limiting the invention as defined by the appended claims and their equivalents.

This application claims priority of Japanese Patent Application No. 2005-033456 filed Feb. 9, 2005, which is incorporated herein by reference.

What is claimed is:

1. A nickel-hydrogen storage battery comprising:
a positive electrode;
an alkaline electrolyte solution; and
a negative electrode containing a hydrogen-absorbing alloy represented by the general formula RE₁₋ₓMgₓNi_{y}Al_{z}Mₐ, where RE is at least one element selected from the group consisting of Zr, Hf, and rare-earth elements including Y; M is an element other than the group IA elements, the group VIIB elements, the group 0 elements, the RE, Mg, Ni, and Al; 0.10≦x≦0.30; 2.8≦y≦3.6; 0<z≦0.30; and 3.0≦y+z+a≦3.6,
the negative electrode having a zirconium compound added thereto.

2. The nickel-hydrogen storage battery according to claim 1, wherein the zirconium compound is zirconium oxide.

3. The nickel-hydrogen storage battery according to claim 2, wherein the zirconium oxide is added to the hydrogen-absorbing alloy in an amount of from 0.25 weight % to 0.35 weight % with respect to the hydrogen-absorbing alloy.

4. The nickel-hydrogen storage battery according to claim 1, wherein the nickel-hydrogen storage battery is aged before being initially charged.

5. The nickel-hydrogen storage battery according to claim 2, wherein the nickel-hydrogen storage battery is aged before being initially charged.

6. The nickel-hydrogen storage battery according to claim 3, wherein the nickel-hydrogen storage battery is aged before being initially charged.

7. The nickel-hydrogen storage battery according to claim 4, wherein the nickel-hydrogen storage battery is aged at a temperature within a range of from 45° C. to 80° C.

8. The nickel-hydrogen storage battery according to claim 5, wherein the nickel-hydrogen storage battery is aged at a temperature within a range of from 45° C. to 80° C.

9. The nickel-hydrogen storage battery according to claim 6, wherein the nickel-hydrogen storage battery is aged at a temperature within a range of from 45° C. to 80° C.
